(19) United States
(12) Patent Application Publication
(10) Pub. No.: US 2025/0282578 A1
(43) Pub. Date: Sep. 11, 2025

(54) PULLEY FOR A SUSPENSION ELEMENT

(71) Applicant: Faigle Kunststoffe GmbH, Hard (AT)

(72) Inventor: Tobias KIENREICH, Hörbranz (AT)

(73) Assignee: Faigle Kunststoffe GmbH, Hard (AT)

(21) Appl. No.: 19/075,989

(22) Filed: Mar. 11, 2025

(30) Foreign Application Priority Data
Mar. 11, 2024 (AT) A32/2024

(51) Int. Cl. B66B 15/02

(52) U.S. Cl. CPC B66B 15/02

(57) ABSTRACT

A pulley for a suspension element (2) of an elevator, having at least one bearing (3), a main body (4) and a running-surface shell (5) made of a first plastic, where the at least one bearing (3) is retained by the main body (4), wherein, between the main body (4) and the running-surface shell (5), an intermediate layer (6) joined to the main body (4) and to the running-surface shell (5) is provided, and the intermediate layer (6) contains a second plastic different from the first plastic.

### CROSS-REFERENCE TO RELATED APPLICATIONS

This application claims priority from Austrian Patent Application No. A32/2024, filed Mar. 11, 2024, which is incorporated herein by reference as if fully set forth.

### TECHNICAL FIELD

The present invention relates to a pulley for a suspension element of an elevator, to an elevator, and to a method for manufacturing a pulley.

### BACKGROUND

Pulleys and, in some cases, methods for manufacturing pulleys are disclosed in EP 2679532 A1, WO 2020234172 A1, WO 90/04730 A1, EP 2684831 A1, EP 1902994 A1, WO 02/46086 A1, and GB 1121220.

According to the prior art, the pulley can have a main body and a running-surface shell comprising a first plastic, wherein the at least one bearing is retained by the main body.

In many cases, a running-surface shell made of plastic is desired in modern elevators, because plastics can be efficiently processed by means of injection molding and are lightweight. In order to achieve highly specific properties of the running-surface shell or of the running surface itself, the plastics for the running-surface shell can be specifically selected. For example, particularly low friction or a degree of damping can be achieved in this way.

A challenge here in many cases is processing exotic plastics as well with high process reliability and dependability so that the desired properties of the running-surface shell are indeed established.

### SUMMARY

Therefore, the object of the invention is to specify a pulley for an elevator and a method for manufacturing a pulley for an elevator, wherein desired properties, in particular low friction, can be reliably achieved.

With respect to the pulley, this is achieved by one or more of the features disclosed herein, namely in that, between the main body and the running-surface shell, an intermediate layer joined to the main body and to the running-surface shell is provided, the intermediate layer containing a second plastic different from the first plastic of the running-surface shell.

With respect to the method, the object is achieved by one or more of the features disclosed herein, namely by the following steps:
providing a main body, preferably together with at least one bearing mounted or to be mounted therein,
producing a running-surface shell at least partially from a first plastic and
producing an intermediate layer between the main body and the running-surface shell at least partially from a second plastic different from the first plastic.

Since, according to the invention, an intermediate layer joined to the main body and to the running-surface shell is provided, the manufacturing of the main body can be decoupled from the manufacturing of the running-surface shell. As a result, the pulley can be reliably produced, even if the physical properties of the running-surface shell are incompatible with those of the main body.

The joints between the materials can be form-fitting or force-fitting or can be the result of physical and/or chemical bonding (integral).

For example, if the material of the running-surface shell—unlike the material of the main body—has particularly significant shrinkage, this can be compensated by the intermediate layer. Tests by the applicant have shown, for example, that the running-surface shell can crack if the material of the running-surface shell has significant shrinkage while the material of the main body does not shrink or shrinks less, because significant internal stresses remain in the running-surface shell and they can surpass the strength of the running-surface shell during use.

For example, if the material of the running-surface shell adheres to the material of the main body only unsatisfactorily, an intermediate layer in certain embodiments can have the result that the intermediate layer forms a sufficiently strong joint (integral and/or force-fitting and/or form-fitting) both with the main body and with the running-surface shell.

According to the invention, the intermediate layer is joined directly to the main body and the running-surface shell so that, at the contact surfaces between the intermediate layer and the main body and between the intermediate layer and the running-surface shell, at most an adhesion promoter is present, but not, for example, other intermediate layers.

Particularly preferably, the main body is manufactured as a single piece/monolithically from one material, although, for example, multi-layer embodiments are also conceivable in principle.

The running-surface shell preferably can completely surround and/or cover the main body and the intermediate layer in the circumferential direction.

The running-surface shell can preferably completely surround or cover the main body and the intermediate layer as viewed in an axial cross section.

Particularly preferably, the running-surface shell can be spaced apart from the main body by the intermediate layer over the entire area.

The material of the main body can preferably be metal, in particular steel, or a plastic.

The at least one bearing used can be, for example, a rolling bearing or a plurality of rolling bearings, although plain bearings are also conceivable.

The function of the main body is to retain the at least one bearing.

In particularly preferred embodiments, the running-surface shell can be made of a different material than the intermediate layer.

The statement that the first plastic differs from the second plastic can preferably be understood to mean that the first plastic and the second plastic are not identical. Particularly preferably, the second plastic can be a different type of plastic than the first plastic; for example, the first plastic can be a polyethylene and the second plastic a polyamide.

The method steps according to the invention for manufacturing the pulley do not necessarily have to be performed in the order indicated above.

For example, the production of the intermediate layer could also occur before the production of the running-surface shell and/or the provision of the main body.

Similarly, the production of the intermediate layer and/or the production of the running-surface shell can also occur before the provision of the main body.

However, the method steps are preferably performed in the indicated order.

The mounting of the at least one bearing in the main body can occur before, during or after the performance of the method according to the invention for manufacturing the pulley.

Protection is also sought for an elevator having at least one pulley according to the invention.

The invention can be used in connection with all types of elevators, in particular passenger elevators and cargo elevators.

The pulley is particularly preferably free-running, i.e. not driven.

Advantageous developments of the invention are described below and in the claims.

The first plastic can preferably be a thermoplastic, for example a polyethylene, particularly preferably an ultra-high-molecular-weight polyethylene. Ultra-high-molecular-weight polyethylene is characterized by particularly low friction. Particularly preferably it can be an ultra-high-molecular-weight polyethylene (PE-UHMW) and/or ultra-high-density polyethylene (PE-UHD), which is also called PE-UHMW.

Alternatively or additionally, the first plastic used can be, in particular a polyolefin, a polyoxymethylene (POM, also called polyacetal), a polyamide (PA), a polyethylene terephthalate (PET), a polybutylene terephthalate (PBT), a thermoplastic elastomer (TPE), a polyketone (PK), a fluoropolymer (e.g. a polytetrafluoroethylene, PTFE) and/or a polyetherimide (PEI) and/or a polyester (PES).

Alternatively or additionally, the first plastic used can be a thermoset, such as a phenolic resin, a polyester resin, and/or a silicone.

Alternatively or additionally, the first plastic used can be an elastomer, such as a polyurethane (PU) and/or an ethylene propylene diene rubber (EPDM).

The first plastic can make up more than 50%, preferably more than 75%, particularly preferably more than 90% and very particularly preferably more than 99% of the running-surface shell.

The second plastic can be a thermoplastic, preferably a polyamide, particularly preferably a recycled polyamide.

The second plastic can make up more than 20%, preferably more than 30% and particularly preferably more than 40% of the intermediate layer.

The second plastic can make up less than 80%, preferably less than 70% and particularly preferably less than 60% of the intermediate layer.

Particularly preferably, the intermediate layer can consist of approximately equal parts by weight of the second plastic and the filler.

The first plastic and/or the second plastic can preferably be a plastic which can be processed by means of injection molding.

The intermediate layer can preferably comprise a filler, particularly preferably in the form of a glass fiber filling.

The first plastic and/or the second plastic can contain one or more additives, for example for modifying the tribological properties. Examples would be a dry lubricant, a silicone oil, a tribologically active additive or a mineral filler.

The main body can contain a circumferential depression in which at least some of the intermediate layer and/or the running-surface shell is arranged. As a result, the running-surface shell and/or the intermediate layer can become/be form-fittingly joined to the main body.

Similarly, the running-surface shell can be at least partially arranged in a circumferential recess of the intermediate layer in order to form-fittingly join the running-surface shell to the intermediate layer.

A further integral and/or force-fitting joint between the running-surface shell and the intermediate layer or between the intermediate layer and the main body is not excluded in the context of the invention.

Of course, a plurality of circumferential depressions and/or a plurality of circumferential recesses can also be used instead of a single circumferential depression or circumferential recess.

The at least one bearing can be integrated into the main body. In other words, an outer ring of the at least one bearing can form the main body.

The running-surface shell can contain a running surface, which preferably includes a first wedge profile or is differently structured.

However, in principle, flat belts having no profile can also be used in the context of the invention.

A suspension element which interacts with the at least one pulley can include at least one steel cable, which is preferably embedded in a belt.

The suspension element in the form of the at least one steel cable can be sheathed.

The belt can contain an inner profile which interacts with the running surface of the running-surface shell.

The inner profile can include a second wedge profile.

The running surface corresponds to the inner profile; preferably, the first wedge profile corresponds to the second wedge profile.

In certain embodiments the running surface includes a first wedge profile which cooperates with one or more steel cables as suspension element, wherein the steel cables may be in the recesses of the first wedge profile.

The first and/or the second wedge profile can preferably include a plurality of wedges having a cross section of triangular appearance, for example, preferably with rounded edges.

The wedges, in particular when they mesh with the interacting profile, produce particularly secure lateral guidance of the suspension element on the pulley, while at the same time good damping properties can be achieved.

The running-surface shell and/or the intermediate layer can particularly preferably be produced by injection molding.

The production of the intermediate layer results, in particularly preferred embodiments, in a joint between the intermediate layer and the main body and/or a joint between the intermediate layer and the running-surface shell.

Thus, the main body and/or the running-surface shell is preferably present when the intermediate layer is produced, and the joint between the intermediate layer and the main body and/or between the intermediate layer and the running-surface shell is established during the step of producing the intermediate layer.

Particularly preferably, the running-surface shell can be positioned around the main body in an intended relative position for the pulley before the intermediate layer is produced.

The positioning of the running-surface shell around the main body in the intended relative position can be understood as meaning that the positioning is subject to the usual production inaccuracies. In addition, the process of producing the intermediate layer can result in a process-related shift in the running-surface shell.

The positioning of the running-surface shell around the main body in the intended relative position can be accomplished by inserting the main body and/or the running-surface shell into a molding tool (second mold tool), in particular an injection-molding tool.

All percentage figures should be understood as weight percentages.

### BRIEF DESCRIPTION OF THE DRAWINGS

Further advantages and details of the invention are clear from the figures and from the associated description of the figures. In the drawings:

FIGS. 1A to 1D schematically show an exemplary embodiment, according to the invention, of a pulley in different views,

FIGS. 2A to 2F show schematic depictions for illustrating an exemplary embodiment, according to the invention, of a method for manufacturing a pulley,

FIG. 3 schematically shows an exemplary embodiment, according to the invention, of an elevator,

FIGS. 4A to 4D schematically show another exemplary embodiment, according to the invention, of a pulley in different views,

FIGS. 5A to 5D schematically show another exemplary embodiment, according to the invention, of a pulley in different views, and

FIGS. 6A to 6D schematically show another exemplary embodiment, according to the invention, of a pulley in different views.

### DETAILED DESCRIPTION

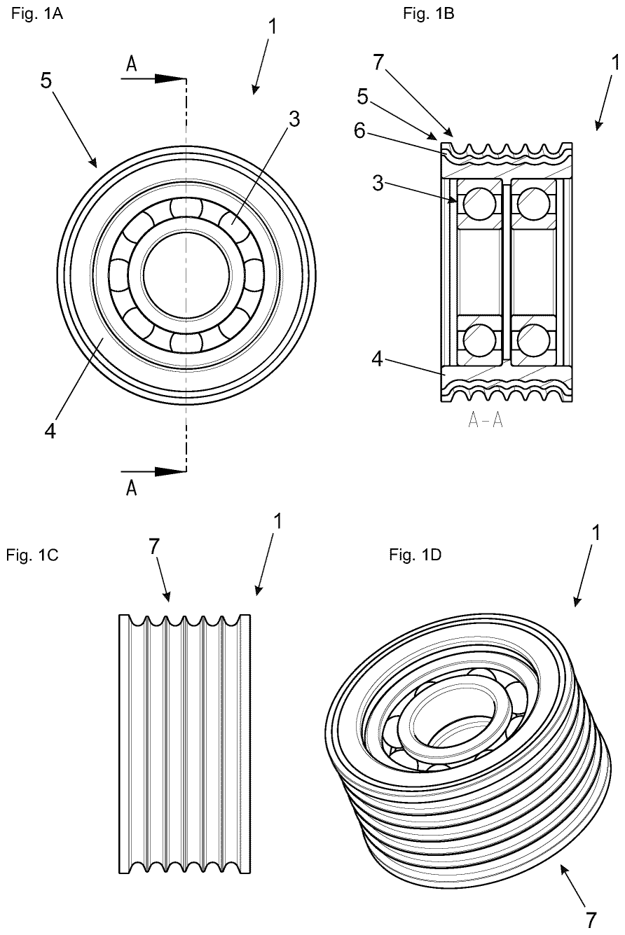

An exemplary embodiment, according to the invention, of a pulley 1 is schematically shown in a front view in FIG. 1A, in a sectional view in FIG. 1B, in a side view in FIG. 1C, and in a perspective view in FIG. 1D.

The pulley 1 includes a main body 4 made of steel, into which two bearings

3, ball bearings here, are pressed.

A running surface 7 of the pulley 1 is formed by a running-surface shell 5, which is joined to the main body 4 by an intermediate layer 6.

In this exemplary embodiment, the running-surface shell 5 is produced from ultra-high-molecular-weight polyethylene (first plastic). Any additives preferably make up less than 1%.

The intermediate layer 6 is produced from a recycled polyamide with a glass fiber filling. Any additives preferably make up less than 1%.

The running surface 7 contains a first wedge profile which can interact with one or more steel cables as suspension element 2.

As can be seen in FIG. 1B, the main body has, at its outer surface, a depression in which part of the intermediate layer 6 is arranged, so that the intermediate layer is at least form-fittingly joined to the main body 4.

Similarly, part of the running-surface shell 5 is arranged in a circumferential recess of the intermediate layer 6, so that there is at least a form-fitting joint here too.

In this exemplary embodiment, the base of the depression and/or of the recess is corrugated, i.e. not completely flat. The wave peaks and wave troughs correspond, in their axial position, to peaks and troughs of the first wedge profile of the running surface 7, as is fundamentally known from WO 2020/234172 A1.

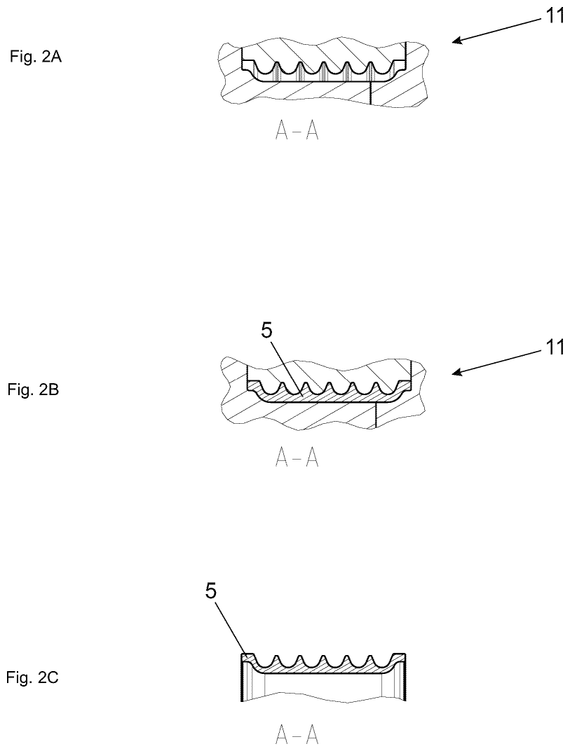

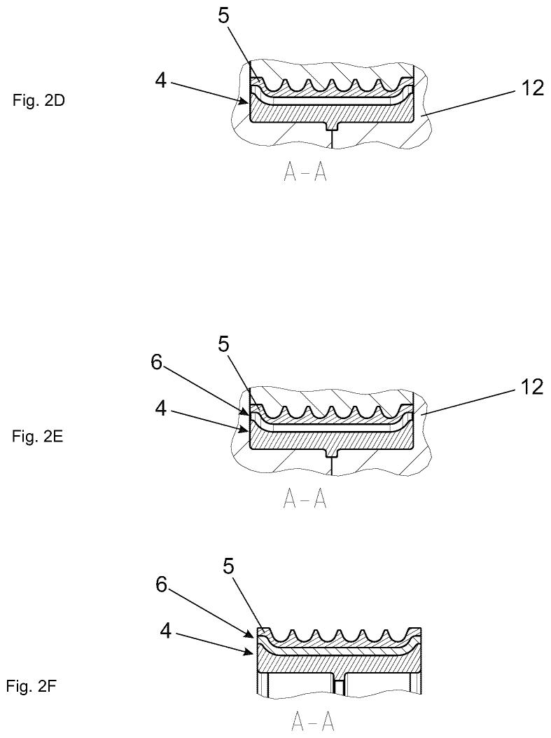

FIGS. 2A to 2F schematically illustrate steps of an exemplary embodiment, according to the invention, of a method for manufacturing a pulley 1.

FIG. 2A shows a first molding tool or mold tool 11. The latter is filled with ultra-high-molecular-weight polyethylene in the context of an injection-molding process, so as to attain the state from FIG. 2B.

The running-surface shell 5 produced in this way cools and is removed from the first mold tool 11 (FIG. 2C). In the mold tool 11 and after the demolding, shrinkage occurs—contraction of the geometry. If a main body 4 with no or little shrinkage were provided here, shrinkage of the running-surface shell 5 would be prevented, resulting in internal stresses in the material of the running-surface shell 5, and these alone, possibly with the added stresses in application, can exceed the strength of the material and thus can lead to fracture of the running-surface shell 5.

Thereafter, the provided main body 4 and the running-surface shell 5 are inserted into a second mold tool 12, namely in such a way that the running-surface shell 5 already assumes the relative position, with respect to the main body 4, that is intended for the pulley, although the relative position can still change to a certain extent, for example as a result of the following additional injection-molding process (FIG. 2D).

As can be seen in FIG. 2E, the intermediate space lying between the main body 4 and the running-surface shell 5 is filled with a second plastic, in the present exemplary embodiment a recycled polyamide with glass fiber filling.

After the intermediate layer 6 has cooled and been demolded, the main body 4, the intermediate layer 6 and the running-surface shell 5 are in the form of a composite body, which is shown in the demolded state in FIG. 2F.

To produce the pulley 1, the bearings 3 are then pressed into the main body 4 in a manner known per se.

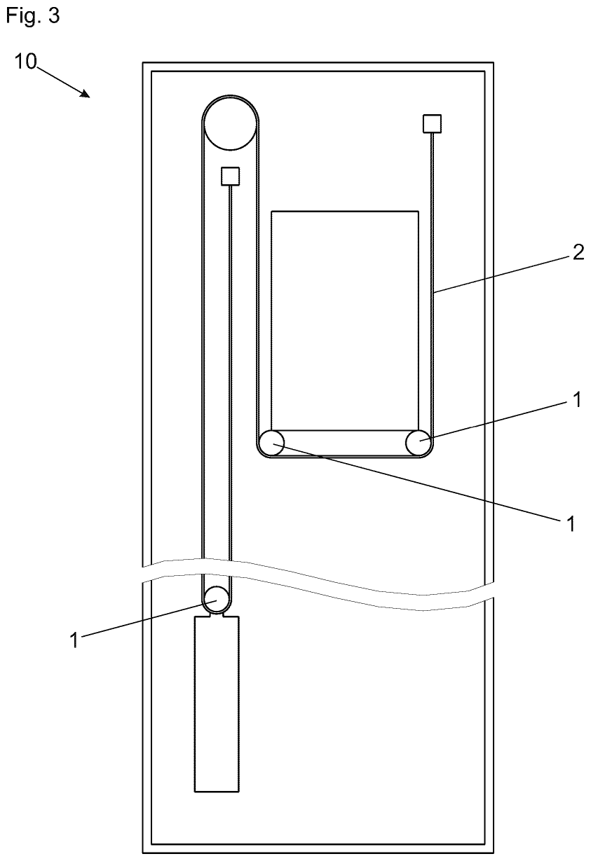

FIG. 3 schematically shows an exemplary embodiment, according to the invention, of an elevator 10 having a plurality of pulleys 1 which interact with a suspension element 2.

In this exemplary embodiment, the pulleys are free-running.

The suspension element can be, for example, a steel cable, a sheathed steel cable or a belt with embedded steel cable, or another conceivable suspension element type appropriate for the application. For example, belts with glass fibers and/or aramid fibers as staple fibers, cut fibers, twisted fibers, continuous fibers and/or filaments can also be used.

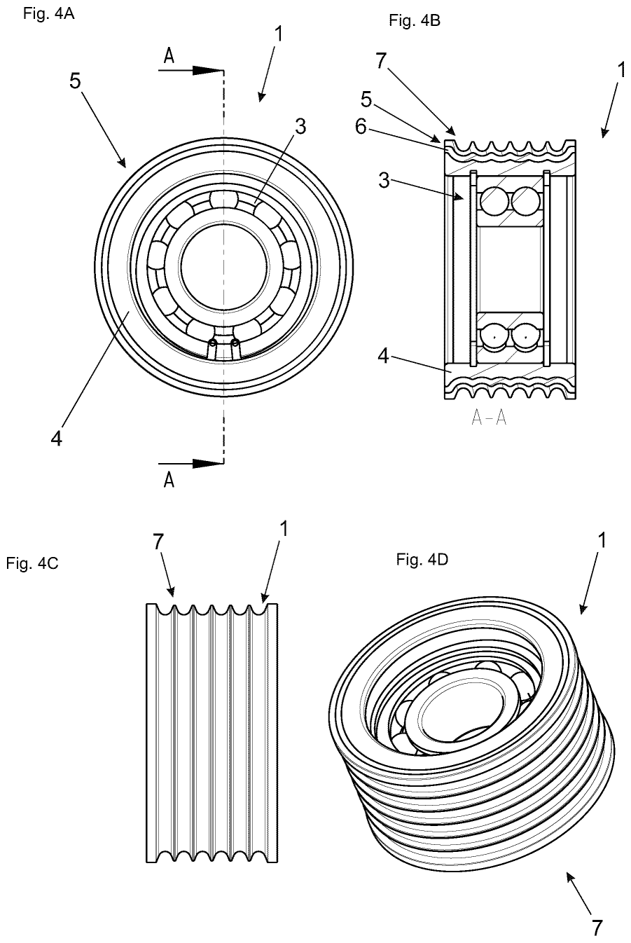

FIGS. 4A to 4D schematically show another exemplary embodiment according to the invention, wherein, in comparison with the exemplary embodiment according to FIGS. 1A to 1D, double-groove bearings 3 are used. Beyond that, the exemplary embodiment is similar to the exemplary embodiment from FIGS. 1A to 1D.

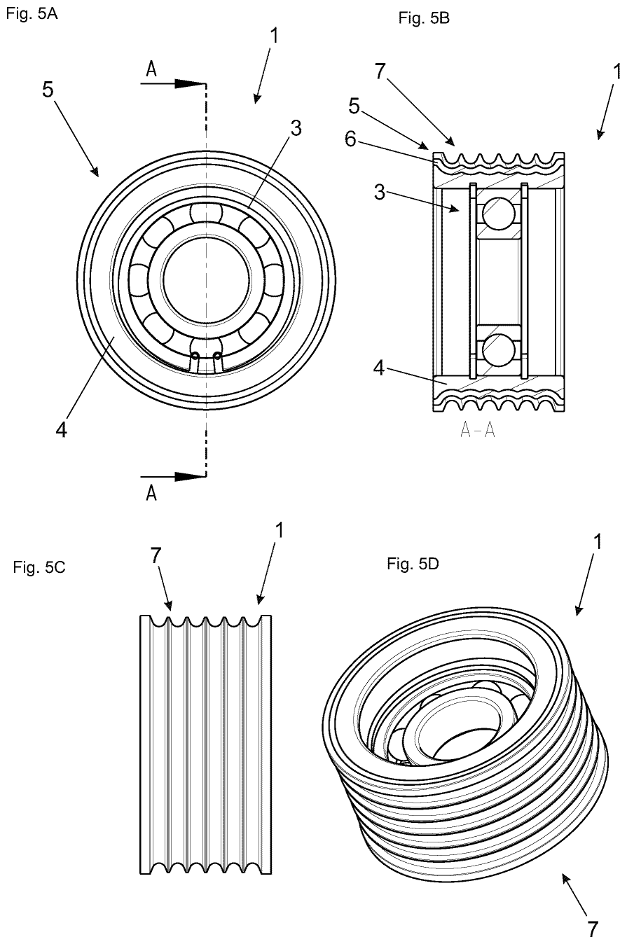

FIGS. 5A to 5D schematically show another exemplary embodiment according to the invention, wherein, in comparison with the exemplary embodiment according to FIGS. 1A to 1D, only one bearing 3 is used. Beyond that, the exemplary embodiment is similar to the exemplary embodiment from FIGS. 1A to 1D.

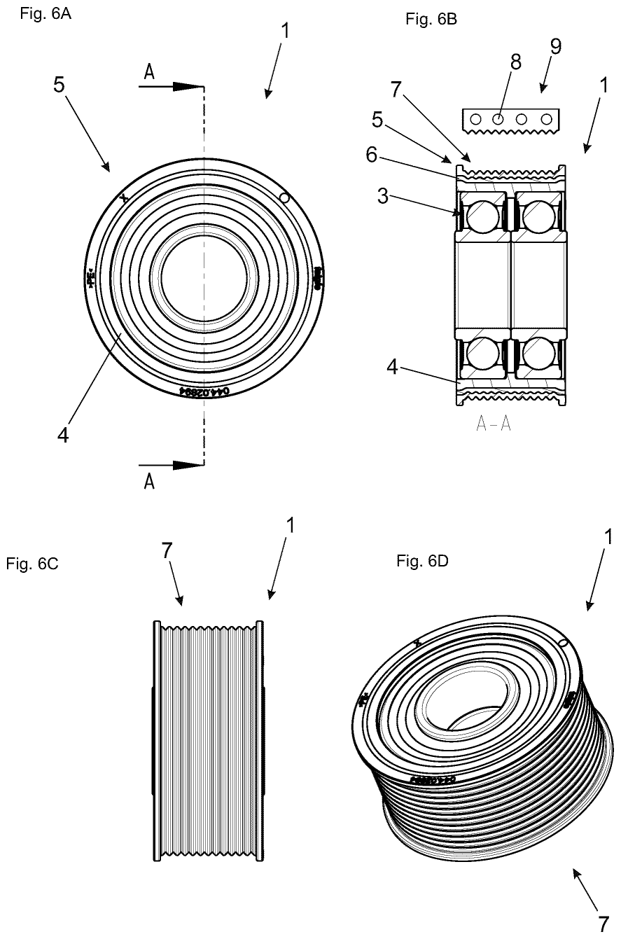

FIGS. 6A to 6D schematically show another exemplary embodiment according to the invention, wherein, in comparison with the exemplary embodiment according to FIGS. 1A to 1D, the running surface 7 interacts with a belt 9 instead of a steel cable as suspension element 2.

The belt 9 is additionally shown schematically in FIG. 6B.

It should be noted that steel cables 8 are embedded in the belt 9.

The belt includes an inner profile, which includes a second wedge profile and interacts with the running surface 7 of the running-surface shell 5.

The first wedge profile of the running surface 7 corresponds to the second wedge profile of the inner profile of the belt 9.

Beyond that, the exemplary embodiment from FIGS. 6A to 6D is similar to the exemplary embodiment from FIGS. 1A to 1D.

It should be mentioned that, according to the invention, flat belts without an inner profile can also be used, and the pulley 1 can, as known per se and in itself in the prior art, be matched to such flat belts.

### LEGEND OF REFERENCE SIGNS

1 Pulley
2 Suspension element
3 Bearing
4 Main body
5 Running-surface shell
6 Intermediate layer
7 Running surface
8 Steel cable
9 Belt
10 Elevator
11 First mold tool
12 Second mold tool

1. A pulley for a suspension element (2) of an elevator, the pulley comprising:
at least one bearing;
a main body;
a running-surface shell comprising a first plastic, wherein the at least one bearing is retained by the main body;
an intermediate layer between the main body and the running-surface shell, the intermediate layer is joined to the main body and to the running-surface shell, and the intermediate layer comprises a second plastic that is different from the first plastic.

2. The pulley according to claim 1, wherein the first plastic is a thermoplastic.

3. The pulley according to claim 1, wherein the first plastic makes up more than 50% of the running-surface shell.

4. The pulley according to claim 1, wherein the second plastic is a thermoplastic.

5. The pulley according to claim 1, wherein the second plastic makes up more than 20% of the intermediate layer.

6. The pulley according to claim 5, wherein the second plastic makes up less than 80% of the intermediate layer.

7. The pulley according to claim 5, wherein the intermediate layer comprises a filler.

8. The pulley according to claim 1, wherein the running-surface shell includes a running surface having a first wedge profile.

9. The pulley according to claim 1, wherein the at least one bearing is integrated into the main body.

10. An elevator having at least one pulley according to claim 1.

11. The elevator according to claim 10, further comprising a suspension element which interacts with the at least one pulley, the suspension element including at least one steel cable.

12. The elevator according to claim 11, wherein the at least one pulley includes the running surface includes a wedge profile, the suspension element includes a belt in which the steel cable is embedded, and the belt includes an inner profile which interacts with the running surface of the running-surface shell.

13. The elevator according to claim 12, wherein the inner profile includes a second wedge profile.

14. The elevator according to claim 13, wherein the running surface corresponds to the inner profile.

15. A method for manufacturing a pulley for a suspension element of an elevator comprising the following steps:
providing a main body together with at least one bearing mounted or to be mounted therein,
producing a running-surface shell at least partially from a first plastic, and
producing an intermediate layer between the main body and the running-surface shell at least partially from a second plastic that is different from the first plastic.

16. The method according to claim 15, wherein at least one of the running-surface shell or the intermediate layer is produced by injection molding.

17. The method according to claim 15, wherein the production of the intermediate layer results in at least one of a joint between the intermediate layer and the main body or a joint between the intermediate layer and the running-surface shell.

18. The method according to claim 15, wherein the running-surface shell is positioned around the main body in an intended relative position for the pulley before the intermediate layer is produced.

19. The pulley according to claim 2, wherein the first plastic is an ultra-high-molecular-weight polyethylene.

20. The pulley according to claim 4, wherein the second plastic is a polyamide.
